(19) United States
(12) Patent Application Publication
(10) Pub. No.: US 2015/0033635 A1
(43) Pub. Date: Feb. 5, 2015

(54) Door Assembly

(71) Applicant: IDEAL SANITARY WARE CO., LTD, Foshan (CN)

(72) Inventor: Wuxiang Wei, Foshan (CN)

(73) Assignee: IDEAL SANITARY WARE CO., LTD, Foshan (CN)

(21) Appl. No.: 14/136,332

(22) Filed: Dec. 20, 2013

(30) Foreign Application Priority Data
Jul. 30, 2013 (CN) 201320458216.3

(51) Int. Cl. E06B 3/92

(52) U.S. Cl. CPC E06B 3/92
USPC 49/505

(57) ABSTRACT

A door assembly is disclosed which comprises a stationary frame and a movable frame. The door assembly is useful for, as an example, maintaining a door in a vertical position even though a wall associated with the door is not exactly vertical. The door assembly can be assembled without drilling operation, minimizing risk of damage to the door frames, and can be assembled by a single person. Other aspects of the door assembly are apparent upon reference to the detailed description.

### CROSS-REFERENCE TO RELATED DOCUMENT

This application claims priority from Chinese Utility Model Application No. 201320458216.3, filed on Jul. 30, 2013, the disclosure of which is incorporated herein by reference in its entirety.

### FIELD OF THE INVENTION

The present invention relates to a door assembly, and in particular, to an adjusting assembly used therein for the adjusting of a stationary frame and a movable frame of the door assembly.

### BACKGROUND OF THE INVENTION

Doors, such as shower doors or balcony doors, are often mounted against wall surfaces and the doors thus mounted are kept as vertical as possible. However, the wall surfaces of buildings are often not exactly vertical, for example, titled toward outside/inside by an angle. Therefore, if the doors are mounted completely along the wall surfaces, the doors may not be smoothly opened or closed. In this regard, it is necessary to adjust the distances between the top/bottom end of a door and a wall surface so as to keep the door in a vertical position.

To achieve this adjustment, a door assembly usually comprises a stationary frame to be attached to a wall surface, and a movable frame connected with a door panel, such as a glass door panel. The stationary frame is firstly attached to the wall surface and then the movable frame is moved toward the stationary frame, during which the distances between the top and bottom ends of the movable frame, and the stationary frame are such adjusted that the movable frame is in a vertical position, and in turn, the door panel is also in a vertical position. The stationary and movable frames are finally connected to each other by drilling thereon and by using fasteners.

However, in one aspect, the drilling operation requires at least two people to cooperate and is very time-consuming. In another aspect, the drilling may inadvertently cause damages to the surfaces of the frames (generally made of aluminum materials), which is undesirable to consumers.

### SUMMARY OF THE INVENTION

An object of the present invention is to provide a door assembly which can be mounted without drilling. Another object of the invention is to provide a door assembly that can be mounted by a single person.

To achieve the objectives, a door assembly is provided which comprises a stationary frame and a movable frame. The door assembly further comprises an adjusting assembly comprising: a fixing element detachably connected with the stationary frame and having a first slot; an adjusting element detachably connected with the movable frame and having a second slot; a deformable element comprising a first step receivable in the first slot, a second step receivable in the second slot, a through hole penetrating through the deformable element, and a gap provided on the first step; and a fastening element receivable in the through hole of the deformable element and engageable with two ends of the through hole. When the fastening element is fastened, the gap on the first step becomes smaller, making the first step and the second step form “V” shaped structures respectively, such that the first step acts on an inner wall of the first slot and the second step acts on an inner wall of the second slot.

The door assembly in the present invention utilizes the fastening force provided by the fastening element that penetrating through the deformable element, to bend the deformable element into a “V” shaped structure, such that the steps thereof act on the slots of the fixing element and the adjusting element, so as to fix the relative position of the deformable element with the fixing element and the adjusting element respectively. Then the relative position of the fixing element and the adjusting element can be fixed such that the relative position of the stationary frame and the movable frame can be fixed.

Preferably, the first slot and the second slot respectively have “T” shaped cross sections, and the deformable element has a “I” shaped cross section. A slot with a “I” shaped cross section can be formed by combination of the two slots to receive the deformable element. Two pairs of the out extending edges of the deformable element with the “I” shaped cross section are used as the steps.

Preferably, the second step is provided with a “V” shaped gap, so as to form a lager bending.

Preferably, the deformable element comprises a first deformable portion having a first inclined plane, and a second deformable portion having a second inclined plane, the first inclined plane and the second inclined plane forming a “V” shaped structure. Dividing the deformable element into two portions can facilitate its deformation when maintaining its rigidity. The upper opening of the “V” shaped structure is used as the gap on the first step.

Preferably, the first deformable portion and the second deformable portion are respectively provided with a positioning hole and a positioning protrusion receivable in the positioning hole, so as to facilitate the alignment of the two portions and avoid rotation thereof.

Preferably, the fastening element comprises a screw and a screw cap matching each other. When the screw is moving toward the screw cap, the distance between the screw and the screw cap becomes shorter, so as to act on two ends of the deformable element to bend the deformable element.

Preferably, the deformable element is provided with a limiting protrusion, and the adjusting element is provided with a limiting recess receiving the limiting protrusion, such that the deformable element can be engaged with the adjusting element to facilitate the mounting.

Preferably, the two ends of the through hole of the deformable element are respectively provided with engaging recesses engageable with the fastening element.

Preferably, the fixing element and the adjusting element are respectively provided with clamping bases, and the stationary frame and the movable frame are respectively provided with clamping slots receiving the clamping base.

The door assembly of the present invention is preferably a shower door assembly, a balcony door assembly or other sliding doors, more preferably a shower door assembly.

The door assembly provided in the present invention can be assembled without drilling operation, minimizing risk of damage to the frames, and can be assembled by a single person.

### BRIEF DESCRIPTION OF THE DRAWINGS

FIG. 1 shows an explosive view of an exemplary door assembly according to one embodiment of the invention.

FIG. 2 shows an explosive view from another direction of the door assembly in FIG. 1.

FIG. 3 shows the relative position of the fixing element and the adjusting element in FIG. 1.

FIG. 4 shows the detailed structure of the deformable element in FIG. 1.

FIG. 5 shows the deformable element in FIG. 1 after deformation.

FIG. 6 shows the door assembly in FIG. 1 in an exemplary mounting way.

Elements that are irrelevant to the spirit of the present invention are omitted for clarity.

### DETAILED DESCRIPTION OF THE INVENTION

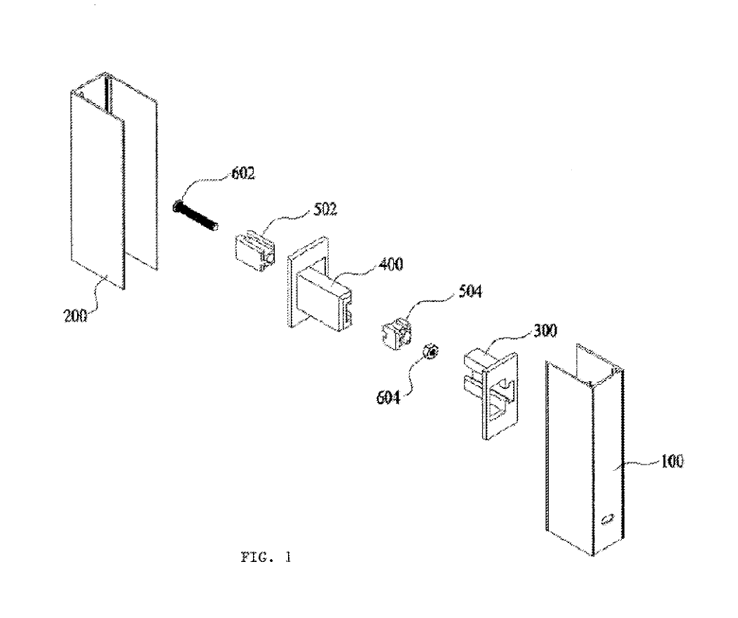

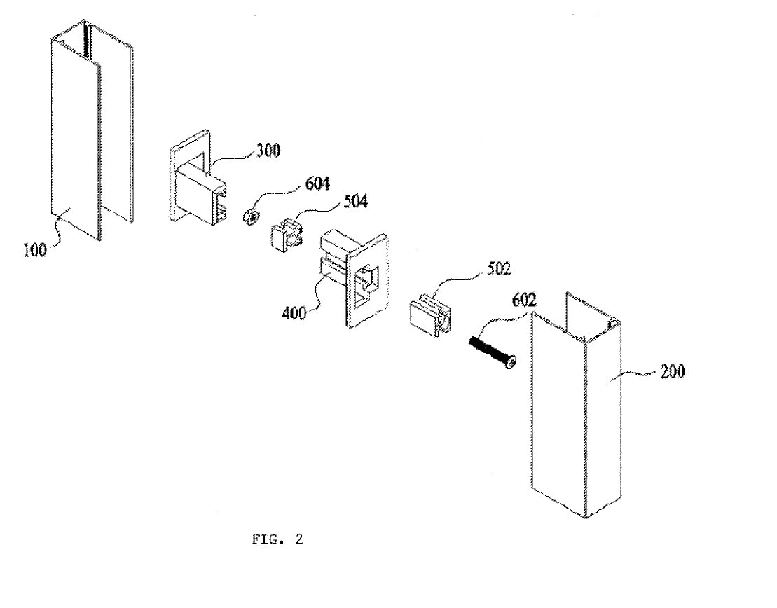

FIGS. 1 and 2 show an exemplary door assembly which is a shower door assembly used generally in a bathroom. The shower door assembly comprises a stationary frame 100, a movable frame 200 and an adjusting assembly. The adjusting assembly comprises a fixing element 300, an adjusting element 400, a deformable element and a fastening element. The fixing element 300 and the adjusting element 400 are respectively detachably connected with the stationary frame 100 and the movable frame 200. The deformable element comprises a first deformable portion 502 and a second deformable portion 504. The fastening element comprises a screw 602 and a screw cap 604.

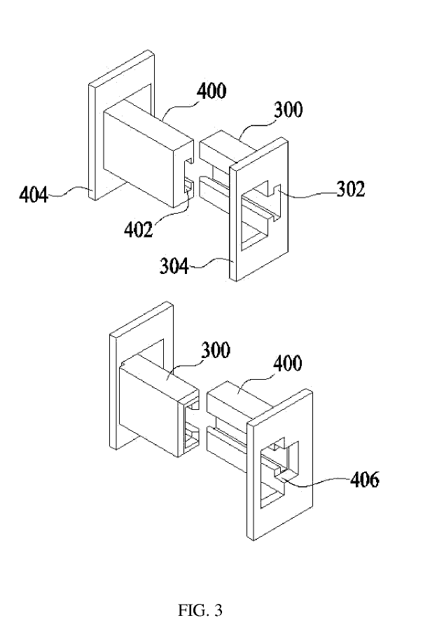

The fixing element and the adjusting element can be detachably connected with the stationary frame and the movable frame in various manners, such as by the matching of a screw and a screw cap. To facilitate the mounting, as shown in FIG. 3, the fixing element 300 and the adjusting element 400 are respectively provided with clamping bases 304 and 404, so as to be respectively connected with the clamping slots of the stationary frame 100 and the movable frame 200 (see FIGS. 1 and 2). The fixing element 300 is provided with a first slot 302, while the adjusting element 400 is provided with a second slot 402. Both of the two slots have “T” shaped cross sections, therefore a slot with a “I” shaped cross section would be formed by combination of the two slots, so as to receive the deformable element.

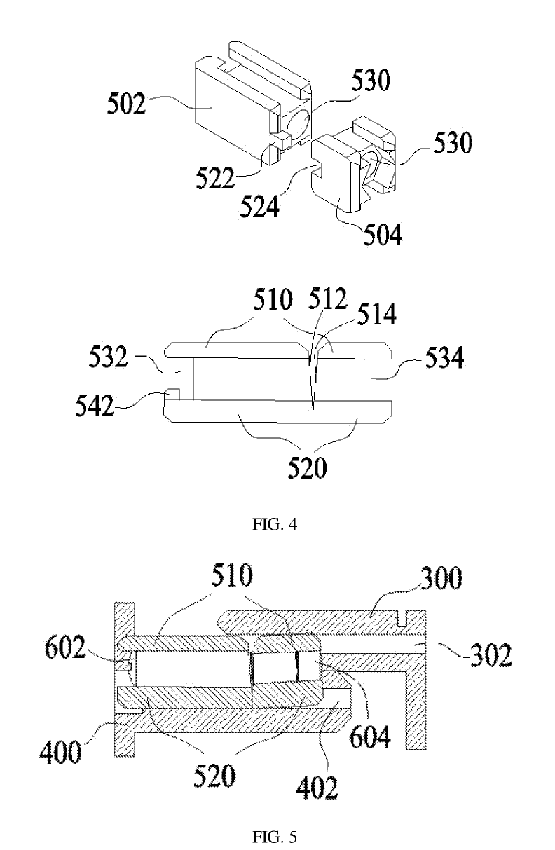

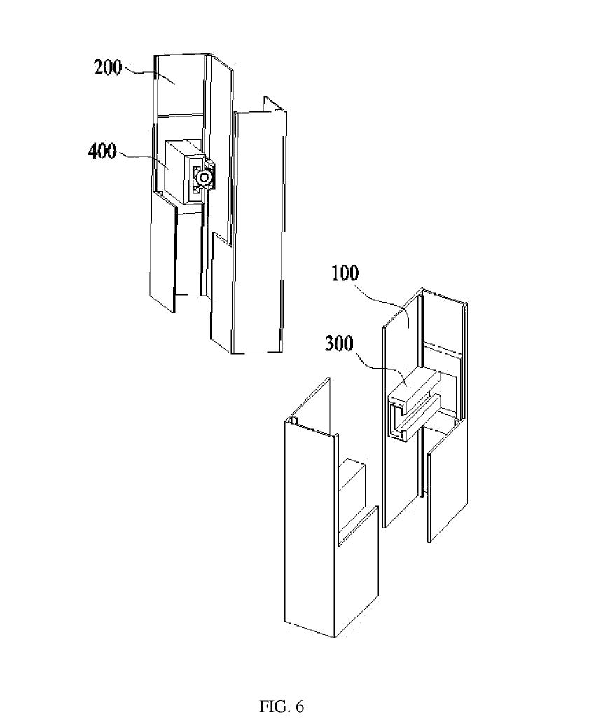

FIG. 4 shows the detailed structure of the deformable element. The deformable element comprises a first step 510 receivable in the first slot, a second step 520 receivable in the second slot, a through hole 530 penetrating through the deformable element, and a gap provided on the first step 510. As shown in FIG. 5, when the fastening elements 602 (only one end is shown) and 604 received in the through hole 530 are fastened, the fastening elements would act on the two ends of the through hole, forcing the gap on the first step 510 to become smaller, such that the first step 510 and the second step 520 would be bent into “V” shaped structures, therefore the first step 510 would act on an inner wall of the first slot 302 and the second step 520 would act on an inner wall of the second slot 402, such that the relative position of the fixing element 300 and the adjusting element 400 can be fixed.

The deformable element can be formed integrally, provided that a “V” shaped structure can be formed when forces are applied on its two ends. The deformable element is preferably made of rigid materials, such that its steps can sufficiently act on the inner walls of the slots in deformation.

To facilitate its deformation when maintaining its rigidity, as shown in FIG. 4, the deformable element comprises a first deformable portion 502 and a second deformable portion 504. The first deformable portion 502 and the second deformable portion 504 combines to form a deformable element with a “I” shaped cross section, and two pairs of the out extending edges of “I” shaped cross section are used as the steps 510, 520.

To achieve the gap on the first step 510, the first deformable portion 502 is provided with a first inclined plane 512, and the second deformable portion 504 is provided with a second inclined plane 514. The first inclined plane and the second inclined plane together form a “V” shaped structure. The upper opening of the “V” shaped structure is used as the gap on the first step 510. To further facilitate the deformation, the second step 520 can also be provided with a “V” shaped gap.

When the deformable element is consisted of two portions, the two portions are preferably engaged with each other in a unique way, so as to form a specific gap to facilitate the deformation. Therefore preferably, as shown in FIG. 4, the first deformable portion 502 is provided with a positioning protrusion 522 on one side, and the second deformable portion 504 is provided with a positioning hole 524 on a corresponding side. By the engagement of the positioning protrusion 522 and the positioning hole 524, a unique alignment of the two portions can be achieved to avoid rotation thereof.

To engage the fastening element with the two ends of the deformable element, the two ends of the through hole of the deformable element are respectively provided with engaging recesses 532, 534. Such that when the fastening element is fastened, forces acting on the deformable element can be provided.

To engage the deformable element with the adjusting element, the deformable element is provided with a limiting protrusion 542, and the adjusting element is provided with a limiting recess 406 (see FIG. 3) receiving the limiting protrusion.

As shown in FIG. 6, during assembly, the adjusting element 400 and the fixing element 300 are mounted to the movable frame 200 and the stationary frame 100 respectively. Then the deformable element is engaged with the adjusting element 400 with the second step received in the second slot. And then the fastening element is put inside the through hole of the deformable element. The first step of the deformable element is inserted into the first slot when the movable frame 200 is moving toward the stationary frame 100. When a suitable position is reached, the fastening element is fastened such that the relative position of one end of the movable frame 200 and one end of the stationary frame 100 is fixed. Therefore when two or more door assemblies are provided, the distances between the movable frame and the stationary frame in different positions can be adjusted, so as to assure that the movable frame is in a vertical position.

The fastening element is a structure whose length can be shortened and thus forces towards inside can be generated. In the examples in the Figures, the fastening element comprises a screw 602 and a screw cap 604 matching each other. When the screw 602 is moving toward the screw cap 604, the distance between the screw and the screw cap becomes shorter, so as to act on two ends of the deformable element and thus bend the deformable element.

It should be understood that various example embodiments have been described with reference to the accompanying drawings in which only some example embodiments are shown. The present invention, however, may be embodied in many alternate forms and should not be construed as limited to only the example embodiments set forth herein.

What is claimed is:

1. A door assembly, comprising a stationary frame and a movable frame, wherein the door assembly further comprises an adjusting assembly comprising:
a fixing element detachably connected with the stationary frame and having a first slot,
an adjusting element detachably connected with the movable frame and having a second slot,
a deformable element comprising a first step receivable in the first slot, a second step receivable in the second slot, a through hole penetrating through the deformable element, and a gap provided on the first step, and
a fastening element receivable in the through hole of the deformable element and engageable with two ends of the through hole,
wherein when the fastening element is fastened, the gap on the first step is made smaller, making the first step and the second step form “V” shaped structures respectively, such that the first step acts on an inner wall of the first slot and the second step acts on an inner wall of the second slot.

2. The door assembly of claim 1, wherein the first slot and the second slot respectively have “T” shaped cross sections, and the deformable element has a “I” shaped cross section.

3. The door assembly of claim 1, wherein the second step is provided with a “V” shaped gap.

4. The door assembly of claim 1, wherein the deformable element comprises a first deformable portion having a first inclined plane, and a second deformable portion having a second inclined plane, the first inclined plane and the second inclined plane forming a “V” shaped structure.

5. The door assembly of claim 4, wherein the first deformable portion and the second deformable portion are respectively provided with a positioning hole and a positioning protrusion receivable in the positioning hole.

6. The door assembly of claim 1, wherein the fastening element comprises a screw and a screw cap matching each other.

7. The door assembly of claim 1, wherein the deformable element is provided with a limiting protrusion, and the adjusting element is provided with a limiting recess receiving the limiting protrusion.

8. The door assembly of claim 1, wherein the two ends of the through hole of the deformable element are respectively provided with engaging recesses engageable with the fastening element.

9. The door assembly of claim 1, wherein the fixing element and the adjusting element are respectively provided with clamping bases, and the stationary frame and the movable frame are respectively provided with clamping slots receiving the clamping bases.

10. The door assembly of claim 1, wherein the door assembly is a shower door assembly or a balcony door assembly.
